(19) United States
(12) Patent Application Publication
(10) Pub. No.: US 2026/0233631 A1
(43) Pub. Date: Aug. 13, 2026

(54) CHARGING STATUS ACTUATION FOR A VEHICLE

(71) Applicant: Ford Global Technologies, LLC, Dearborn, MI (US)

(72) Inventors: Mahmood Tabesh, Northville, MI (US); Hossein Sartipizadeh, Centennial, CO (US); Ahmadreza Mahmoudzadeh, League City, TX (US); Ryan O'Gorman, Beverly Hills, MI (US)

(73) Assignee: Ford Global Technologies, LLC, Dearborn, MI (US)

(21) Appl. No.: 19/049,196

(22) Filed: Feb. 10, 2025

(51) Int. Cl. B60L 55/00; B60L 53/66; B60L 53/68; B60L 58/16

(52) U.S. Cl. CPC B60L 55/00; B60L 53/66; B60L 58/16; B60L 53/68

(57) ABSTRACT

A computer may be programmed to receive a first set of charging status data about a vehicle and receive a second set of charging status data about a household associated with the vehicle. Based on the sets of charging status data the computer may simulate electrical usage by the vehicle and the household to generate a third set of charging status data. The computer may actuate at least one of the vehicle or the household to charge according to the third set of charging status data.

### BACKGROUND

Vehicles typically include sensors for collecting data about the vehicle and/or an environment around the vehicle. In some examples, sensor data can be used by vehicle systems to actuate vehicle components based on data about objects around the vehicle. Vehicles can also include speakers to output sound. For example, vehicle speakers may output sound for an occupant's telephone call or the like.

### BRIEF DESCRIPTION OF THE DRAWINGS

FIG. 1 is a block diagram illustrating an example vehicle system and household system.

FIGS. 2A-F are timelines illustrating an example third set of charging status data.

FIG. 3 is a process flow diagram illustrating an example process for actuating entities to charge according to a set of charging status data.

### DETAILED DESCRIPTION

### Introduction

Described herein are techniques actuating at least one of a vehicle or a household to charge according to a set of charging status data. A computer may receive a first set of charging status data about a vehicle and a second set of charging status data about a household associated with the vehicle. Based on the sets of charging status data, the computer may simulate electrical usage by the vehicle and the household to generate a third set of charging status data. The computer may actuate at least one of the vehicle or the household to charge according to the third set of charging status data.

Accordingly, included in the present disclosure is a system comprising a computer having a processor and a memory, the memory storing instructions executable by the processor to: receive a first set of charging status data about a vehicle, receive a second set of charging status data about a household associated with the vehicle, based on the sets of charging status data simulate electrical usage by the vehicle and the household to generate a third set of charging status data, and actuate at least one of the vehicle or the household to charge according to the third set of charging status data.

The first set of charging status data may include a vehicle charging schedule.

The second set of charging status data may include a utilities plan of the household.

The sets of charging status data may include user preferences.

The second set of charging status data may include household power consumption.

The first set of charging status data may include operation patterns of the vehicle.

The sets of charging status data may include a level of charge to be transferred between the household and the vehicle.

The instructions may further include instructions to charge according to the third set of charging status data based on a determination to override user preferences.

The third set of charging status data may include optimizing a service-life of a battery by interrupting the charge.

The third set of charging status data may include a selection from a plurality of preset charging programs.

Generating the third set of charging status data may include optimizing an estimation of monetary savings compared with the first and second sets of charging status data.

A method comprises receiving a first set of charging status data about a vehicle, receiving a second set of charging status data about a household associated with the vehicle, based on the sets of charging status data simulating electrical usage by the vehicle and the household to generate a third set of charging status data, and actuating at least one of the vehicle or the household to charge according to the third set of charging status data.

The first set of charging status data may include a vehicle charging schedule.

The second set of charging status data may include a utilities plan of the household.

The sets of charging status data may include user preferences.

The second set of charging status data may include household power consumption.

The first set of charging status data may include operation patterns of the vehicle.

The sets of charging status data may include a level of charge to be transferred between the household and the vehicle.

The method may further comprise charging according to the third set of charging status data based on a determination to override user preferences.

Generating the third set of charging status data may include optimizing a service-life of a battery by interrupting the charge.

### Exemplary System Elements

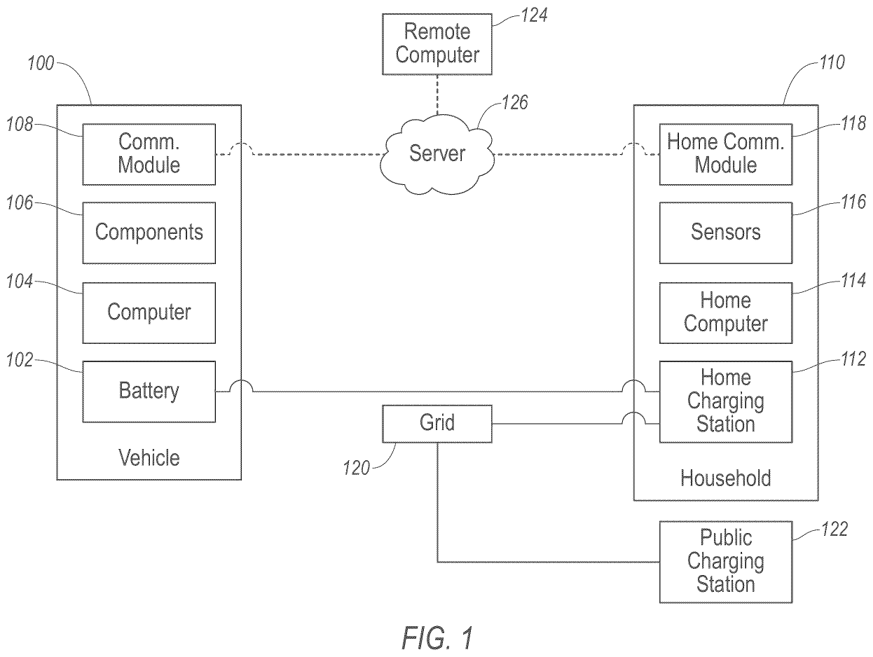

FIG. 1 is a block diagram of a system including a vehicle 100 and a household 110. The vehicle 100 may be any passenger or commercial automobile such as a car, a truck, a sport utility vehicle, a crossover, a van, a minivan, a taxi, etc. The vehicle 100 is an electric vehicle, for example, a BEV (Battery Electric Vehicle), a hybrid electric vehicle, a PHEV (Plug-in Hybrid Electric Vehicle), etc. The vehicle 100 includes a traction battery 102, a vehicle computer 104, a plurality of components 106, and a communication module 108.

The vehicle 100 includes the vehicle computer 104 having a memory that includes instructions executable by a processor of the vehicle computer 104 to carry out processes and operations including as described herein. The memory of the vehicle computer 104 includes one or more forms of computer readable media, and stores instructions executable by the vehicle computer 104 for performing various operations, including as disclosed herein. For example, the vehicle computer 104 can be a generic computer with a processor and memory as described above and/or may include an electronic control unit (ECU) or controller for a specific function or set of functions, and/or a dedicated electronic circuit including an application specific integrated circuit (ASIC) that is manufactured for a particular operation (e.g., an ASIC for processing sensor data and/or communicating the sensor data). In another example, the vehicle computer 104 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). In some examples, a combination of processor(s), ASIC(s), and/or FPGA circuits may be included in the vehicle computer 104. The vehicle computer 104 may be embodied as multiple computers coupled together.

The memory can be of any type (e.g., hard disk drives, solid state drives, servers, or any volatile or non-volatile media). The memory can be a separate device from the vehicle computer 104, and the vehicle computer 104 can retrieve data stored by the memory via the communications network in the vehicle 100 (e.g., over a CAN bus, a wireless network, etc.). Alternatively or additionally, the memory can be part of the vehicle computer 104 (e.g., as a memory of the vehicle computer 104).

The vehicle computer 104 may include programming to operate one or more of components 106 of the vehicle 100 such as propulsion (e.g., control of speed in the vehicle 100 by controlling one or more of an internal combustion engine, electric motor, hybrid engine, etc.), steering, interior and/or exterior lights, speakers, etc. The components 106 include any part of the vehicle 100 that draws power and is actuatable to perform some operation.

The vehicle computer 104 may be communicatively coupled via the communication network with the components 106 and the communication module 108 in the vehicle 100. The vehicle computer 104 is generally arranged for communications on the communication network that can include a bus in the vehicle 100 such as a controller area network (CAN) or the like, and/or other wired and/or wireless mechanisms. Alternatively or additionally, in cases where the vehicle computer 104 actually comprises a plurality of devices, the communication network may be used for communications between devices represented as the vehicle computer 104 in this disclosure.

A traction battery 102 stores energy that may be used by devices or components 106 requiring electricity in the vehicle 100 and/or the household 110. The traction battery 102 may provide a high voltage direct current (DC) output. A contactor module may include one or more contactors to isolate the traction battery 102 from a high-voltage bus when opened and to connect the traction battery 102 to the high-voltage bus when closed. One or more power electronics modules (which may also be referred to as an inverter or power module) may be electrically coupled to the source-voltage bus. The power electronics modules are electrically coupled to the vehicle 100 and may be coupled to a charging station 112, 122 and provide the ability to bi-directionally transfer energy between the traction battery 102 and the vehicle 100 and/or charging stations 112, 122. For example, a traction battery 102 may provide a DC voltage while devices in the household 110 may operate with a three-phase alternating current (AC). The power electronics module may convert the DC voltage to a three-phase AC current to operate the household devices. Alternatively, or additionally, the power electronics module may convert the three-phase AC current from the household devices acting as generators to the DC voltage compatible with the traction battery 102. The traction battery 102 may be a high-voltage (HV) battery including one or more battery cells linked to one another to power components 106 of the vehicle 100 such as the motor. For the purposes of this disclosure, “high voltage” is defined as at least 60 volts direct current or at least 30 volts alternating current, and “low voltage” is defined as less than 60 volts direct current or less than 30 volts alternating current. For example, the high-voltage direct current on the vehicle 100 may be on the order of 400 volts, and the low-voltage direct current on the vehicle 100 may be 12 or 48 volts. The traction battery 102 may be rechargeable. For example, the traction battery 102 may include an electrolyte which allows ions to move between an anode and cathode during discharge, and then return during recharge when connected to a charging station 112, 122.

In addition to providing energy for propulsion, the traction battery 102 may provide energy for other vehicle components 106. The vehicle 100 may include a DC/DC converter module that converts the high voltage DC output from the high-voltage bus to a low-voltage DC level of a low-voltage bus that is compatible with low-voltage loads. Examples of low-voltage electrical loads may be cabin lighting or dashboard lighting whereas high-voltage electrical loads may be a fan, an electric heating element and/or an air-conditioning compressor.

The traction battery 102 may have a state of charge (SOC) indicating the amount of electrical charge stored in the traction battery 102. The traction battery 102 may include sensors such as a current sensor and voltage sensor. The current sensor and voltage sensor outputs of the traction battery 102 are all provided to the vehicle computer 104. The vehicle computer 104 may be programmed to compute a state of charge (SOC) based on the signals from the current sensor and the voltage sensor of the traction battery 102. Various techniques may be utilized to compute the state of charge. For example, an ampere-hour integration may be implemented in which the current through the traction battery 102 is integrated over time. The SOC may also be estimated based on the output of the traction battery 102 voltage sensor. The specific technique utilized may depend upon the chemical composition and characteristics of the particular battery 102.

The household 110 may be any structure including infrastructure for charging the traction battery 102. The household 110 includes a home charging station 112, home computer 114, sensors 116, and a home communication module 118. In examples given herein, the household 110 is a private home belonging to an operator of the vehicle 100. However, the household 110 may be a parking garage, a place of work, a public area, etc.

The traction battery 102 may be recharged by a power source such as a charging station 112, 122. The charging station 112, 122 may be a connection to an electrical outlet. An external power source may be electrically coupled to the charging station 112, 122. The charging station 112, 122 may also be an electrical power distribution network or grid 120 as provided by an electric utility company. The charging station 112, 122 provides circuitry and controls to manage the transfer of energy between the grid 120 and the vehicle 100. The charging station 112, 122 may provide DC or AC electric power to the vehicle 100. The charging station 112, 122 may include a charge connector for plugging into a charge port of the vehicle 100. The charge port may be any type of port configured to transfer power from the charging station 112, 122 to the vehicle 100. The charge port may be electrically coupled to a charge module or on-board power conversion module which may condition power supplied from the charging station 112, 122 to provide the proper voltage and current levels to the traction battery 102. The charge connector may have pins that mate with corresponding recesses of the charge port. Alternatively, various components described as being electrically coupled or connected may transfer power using wireless inductive coupling or other non-contact power transfer mechanisms.

The charging station 112, 122 may be one of a home charging station 112 or a public charging station 122. The home charging station 112 may be a personal charging station belonging to the operator of the vehicle 100 and configured to recharge or discharge the traction battery 102 upon electrical connection of the vehicle 100 to the home charging station 112. The public charging station 122 may be a charging station not owned by the operator of the vehicle 100 (e.g., a charging station in a public parking garage).

As described in more detail below, the home charging station 112 may be operated based on one or more algorithms stored by one or more computers 104, 114, 124.

The household 110 may include a home computer 114. The home computer 114 may have a memory that includes instructions executable by a processor of the home computer 114 to carry out processes and operations including as described herein. The memory of the home computer 114 includes one or more forms of computer readable media, and stores instructions executable by the home computer 114 for performing various operations, as described above. The home computer 114 may, for example, be a personal computer. As another example, the home computer 114 may be one or more devices included in the home charging station 112.

The household 110 may include a variety of sensors 116. A sensor 116 is a device that can obtain one or more measurements of one or more physical phenomena. Some sensors 116 detect objects, for example, radar sensors, scanning laser range finders, light detection and ranging LIDAR devices, pressure sensors, and image processing sensors such as cameras. The home computer 114 may receive data from the sensors 116 and determine a location of the vehicle 100 based on the sensor data. As an example, the home computer 114 may receive a specific weight from pressure sensors 116 and image data from image sensors 116 which the home computer 114 may feed through a stored algorithm to determine the presence of a vehicle 100 in the household 110.

As mentioned above, the charging stations 112, 122 may be electrically connected to the grid 120, which provides an electrical power supply (e.g., an electrical power distribution network) to a consumer as provided by an electric utility company. An electrical grid 120 is a network of power supply from sources to end-points including power stations, substations, power lines, etc.

The computers 104, 114 may be in remote communication (e.g., via the communication modules 108, 118) with a remote server 126. The remote server 126 may be supported by a remote computer 124. The remote computer 124 may, for example, be one or more computers. The remote computer 124 may, via the server 126, provide instructions to the vehicle computer 104 and the home computer 114.

The following steps may be performed by the vehicle computer 104, the home computer 114, and/or the remote computer 124, which will be referred to collectively as the computer 104, 114, 124. The computer 104, 114, 124 may receive a first set of charging status data from the vehicle 100 and a second set of charging status data from the household 110. The computer 104, 114, 124 may input the first set of charging status data and the second set of charging status data to an algorithm to output the third set of charging status data. The algorithm is herein referred to as the “charge algorithm.” The charge algorithm performs operations that account for historical parking data of the vehicle 100, desired SOC of the traction battery 102, utilities plans, electrical consumption of the electrical devices in the household 110, user preferences, etc. The operation of the charge algorithm will be described in further detail below. The data which may be included in the first and second sets of charging status data and input to the charge algorithm are described in turn.

The computer 104, 114, 124 may receive a first set of charging status data about the vehicle 100. The first set of charging status data may include a vehicle charging schedule, operation patterns of the vehicle 100, user preferences, and a level of charge to be transferred between the household 110 and the vehicle 100, each of which will be described in turn below.

The first set of charging status data includes a vehicle charging schedule. The vehicle charging schedule indicates periods of time when the vehicle 100 is connected to the charging station 112, 122 and either recharging (e.g., to prepare for further driving) or discharging (e.g., to provide charge to household electrical devices) the traction battery 102. The charging schedule may be specified to the computer 104, 114, 124 by the operator of the vehicle 100 and/or predicted by the computer 104, 114, 124 based on historical vehicle data, confidence of an upcoming charging period weighted based on the time of day, etc. In other words, the vehicle charging schedule in the first set of charging data may be assumed to match historical data. The computer 104, 114, 124 may aggregate and analyze the historical data by inputting the data to algorithms stored at one or more computers 104, 114, 124 to reveal patterns associated with charging and usage and thereby determine the most likely charging schedule of the vehicle 100.

The first set of charging status data includes operation patterns of the vehicle 100. Operation patterns include the SOC of the traction battery 102 when the vehicle 100 is connected to the charging station 112, 122, SOC upon disconnecting the vehicle 100 from the charging station 112, 122 so as to allow the vehicle 100 to reach a destination, etc. Similarly to determining a charging schedule of the vehicle 100 based on historical data, the computer 104, 114, 124 may predict operation patterns of the vehicle 100 based on historical data. In other words, the operation patterns in the first set of charging data may be assumed to match historical data. For example, the computer 104, 114, 124 may determine operation patterns based on historical data indicating that at specific times of the day during specific days of the week, the vehicle 100 disconnects from the charging station 112, 122 with a SOC within a 10% range of 80% SOC and subsequently reconnects to the charging station 112, 122 with a SOC within a 10% range of 30% SOC. Additionally, the computer 104, 114, 124 may determine operation patterns of the vehicle 100 based on data input from the operator (e.g., specifying a vehicle 100 usage schedule of the operator).

The first set of charging status data includes user preferences. In addition to the operator input described above, the operator may specify preferences to the computer 104, 114, 124. User preferences include, for example, a minimum SOC (e.g., 40%) to be maintained at all times after being reached when connected to the charging station 112, 122. As another example, the operator may specify that the traction battery 102 may only discharge to the household 110 at specific times of day.

The first set charging status data includes a level of charge to be transferred between the household 110 and the vehicle 100. As described above, the traction battery 102 may be recharged by the public charging station 122 and may discharge to the home charging station 112 so as to provide charge to electrical devices in the household 110, thereby decreasing the consumption of electricity from a utility provider by the household 110. As an example, the computer 104, 114, 124 may determine based on operating patterns of the vehicle 100 that a minimum of 40% SOC is needed for the vehicle 100 to reach a destination (e.g., an office building on a weekday morning). In such an example, the computer 104, 114, 124 may discharge the traction battery 102 to 40% SOC. As another example, as mentioned above, the operator may specify a minimum or maximum SOC to the computer 104, 114, 124.

The computer 104, 114, 124 may receive a second set of charging status data about a household 110 associated with the vehicle 100. The second set of charging status data may include a utilities plan of the household 110, household power consumption by the household 110, and a level of charge to be transferred between the household 110 and the vehicle 100, each of which will be described in turn below.

The second set of charging status data includes a utilities plan of the household 110. That is, the computer 104, 114, 124 may store data about the utilities plan of the household 110 such as the providing company, scheduled blackouts, pricing, etc. As described in further detail below, the computer 104, 114, 124 can utilize this data to determine more price-efficient plans for the household 110.

The second set of charging status data includes household 110 power consumption. The computer 104, 114, 124 may receive data from the household 110 (e.g., from meter observation software) which measures the electrical consumption of all electrical devices in the household 110 (e.g., in Watts). For example, the computer 104, 114, 124 may be in remote communication with a charge consumption device which may be connected to an electrical panel of the household 110. The computer 104, 114, 124 may determine a consumption pattern of the household 110 based on relative levels of electrical consumption throughout the day.

The second set of charging status data includes a level of charge to be transferred between the household 110 and the vehicle 100. That is, based on user input and/or other charging status data such as a minimum SOC requirement or the electrical consumption of the household 110, the computer 104, 114, 124 may determine a level of charge to be discharged from the traction battery 102 to the household 110 via the home charging station 112. For example, the computer 104, 114, 124 may discharge the battery 102 until the battery 102 reaches 40% SOC (e.g., the minimum SOC required for the vehicle 100 to make a scheduled journey). As another example, the computer 104, 114, 124 may discharge the traction battery 102 when the electrical consumption of the household 110 is within a threshold consumption. The threshold consumption may be specified by an operator or stored in instructions in the memory of the computer 104, 114, 124. The threshold consumption may be such that the traction battery 102 is discharged when the household 110 is consuming a relatively low amount of charge. For example, if the household 110 on average consumes 1,000 Watts of electricity per hour, the threshold may be 500 Watts per hour such that the traction battery 102 discharges when the consumption of the household 110 decreases below 500 Watts per hour.

Based on the first and second sets of charging status data, the computer 104, 114, 124 may simulate electrical usage by the vehicle 100 and the household 110 to generate a third set of charging status data. That is, the computer 104, 114, 124 may run a simulation utilizing the first and seconds sets of charging status data as inputs. The simulation may account for the first and second sets of charging status data (e.g., utilities plans, customer preferences, operations patterns of the vehicle, etc.) and output a third set of charging status data based on the first and second sets of charging status data. The third set of charging status data defines how to charge and/or discharge the vehicle 100 and/or the household 110 based on an optimization of the first and second sets of charging status data by the ICA which the computer 104, 114, 124 proposes to the user for adoption as a schedule for the vehicle. In other words, the computer 104, 114, 124 may run a simulation to generate third sets of charging status data which propose various plans to the user. As described throughout this document, the simulation may output third sets of charging status data which recommend utilities plans, subscription services, charging schedules, etc. In some examples used herein, the charge algorithm optimizes the third set of charging status data according to the price-efficiency of the electrical consumption of the household 110.

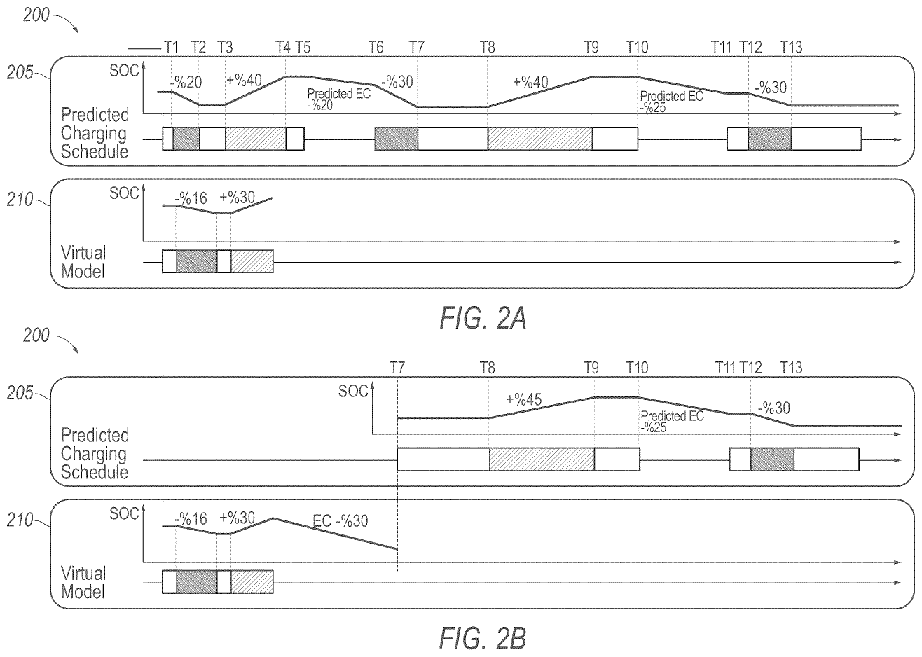

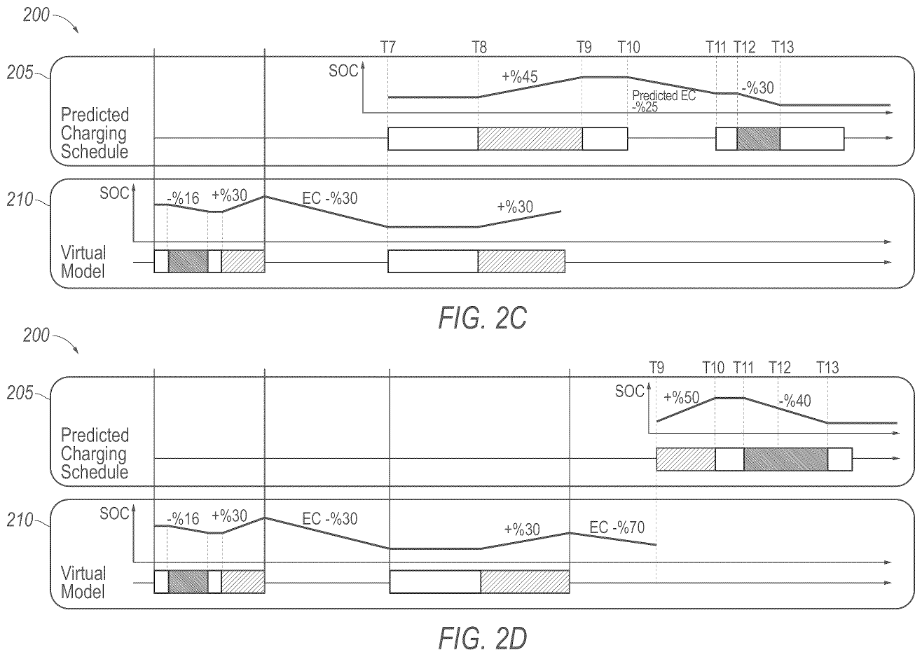

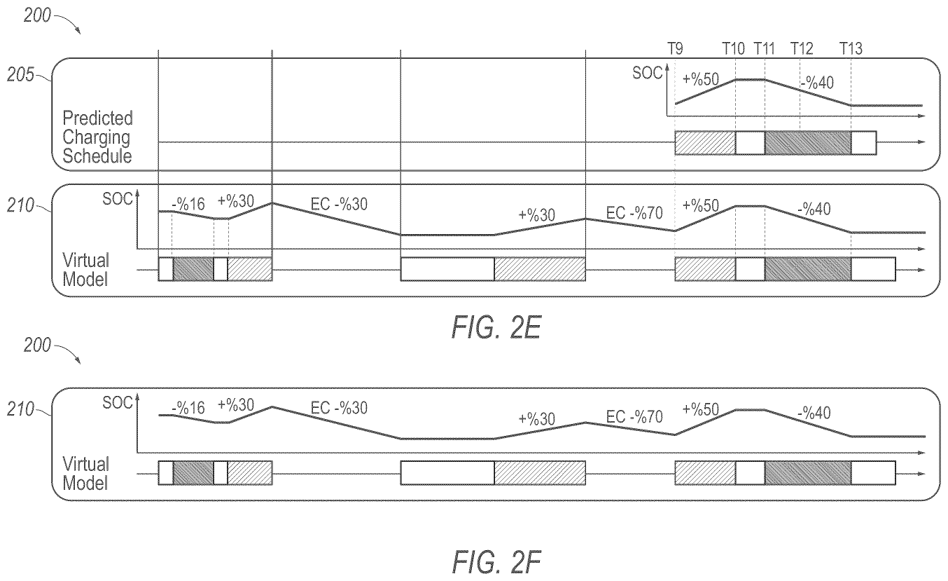

FIG. 2 illustrates an example timeline simulation based on the first and second sets of charging status data. FIG. 2 shows the simulation 200 including a predicted charging schedule 205 and a virtual model 210 of the third set of charging status data. The simulation 200 is based on the first and second sets of charging status data. The predicted charging schedule 205 is determined by the computer 104, 114, 124 to model a predicted driving and charging schedule of the vehicle 100 based on historic data. The virtual model 210 represents the real-time data of the vehicle 100 adjusted according to the simulation run by the computer 104, 114, 124 (e.g., the vehicle 100 may be disconnected from the home charging station 112 prior to a time predicted by the predicted charging schedule 205). For example, if the predicted charging schedule 205 predicts that the vehicle 100 is parked until a specified time and the vehicle 100 actually begins a journey at an earlier time, the virtual model 210 updates to reflect the deviation from the predicted schedule 205 by depicting the parking time as ending at the time of departure. FIG. 2A depicts a first iteration of the simulation 200 with the actual data from the vehicle represented as the virtual model 210. FIGS. 2B-2F depict further updated iterations of the simulation 200 in which the virtual model 210 has deviated from the predicted charging schedule 205 in the simulation 200. Periods of discharging are represented by dark shaded blocks and periods of charging are represented by blocks with diagonal lines. Periods when the vehicle 100 is plugged into one of the charging stations 112, 122 and not being charged or discharged are represented by unshaded blocks.

The computer 104, 114, 124 may store a trigger which prompts the computer 104, 114, 124 to update the simulation 200. The trigger may be any event permitting the accuracy of the simulation 200 to be checked. In examples used herein, the trigger is the connecting of the vehicle 100 to the charging station 112 and disconnecting of the vehicle 100 from the charging station 112. When the vehicle 100 is connected to the charging station 112 the computer 104, 114, 124, via the ICA, determines the third set of charging status data as will be described in further detail below. When the vehicle 100 is disconnected from the charging station 112, the computer 104, 114, 124 updates the simulation 200 via the charge algorithm based on the adherence of the vehicle 100 to the third set of charging status data. So, for example, if the vehicle 100 is connected to the home charging station 112 with a SOC of 60%, and has a planned journey requiring 60% SOC in four hours, the simulation 200 may recommend to discharge to the minimum required SOC (e.g., 30%) and recharge back to at least 60%. The computer 104, 114, 124 may further adjust the simulation 200 based on the time-to-charge of the traction battery 102. For example, the computer 104, 114, 124 may calculate the time required to recharge the traction battery 102 to 60% from the minimum required SOC and allot time in the simulation 200 to allow for the recharging. Furthermore, if the traction battery 102 discharges to the minimum required SOC in a shorter amount of time than first simulated (e.g., due to higher household 110 power consumption) the computer 104, 114, 124 may update the simulation 200 to recommend a longer charging period such that the traction battery 102 may have a higher SOC than 60%.

As mentioned above, the computer 104, 114, 124 may run a simulation 200 based on the first and second sets of charging status data to output the third set of charging status data (e.g., proposed plans for electrical usage). The computer 104, 114, 124 may generate the third set of charging status data from the simulation via the charge algorithm. The charge algorithm may be an algorithm which references one or more look up tables regarding how the traction battery 102 should be charged and how the charge power of the traction battery 102 should be distributed. In at least one embodiment, outgoing charge power is distributed between the traction battery 102 and the household 110 based on the configurations specified in the applicable look up table(s). In various embodiments, there are multiple look up tables that are simultaneously applicable to the third set of charging status data. In other embodiments some—but not all—look up tables are applicable to the third set of charging status data. Users may have the option to specify whether some or all look up tables should be actively utilized in the third set of charging status data.

The lookup table may be prestored by the computer 104, 114, 124. The lookup tables may specify how to run the simulation 200 based on the first and second sets of charging status data. The computer 104, 114, 124 may further store instructions specifying a variety of potential third sets of charging status data to be propagated through the simulation 200 based on various scenarios. For example, the computer 104, 114, 124 may store instructions to run the simulation 200 and propagate a potential third set of charging status data based on potential usage of a specific preset charging program and also based on extending a life of the traction battery 102. In such an example, the computer 104, 114, 124 may generate a third set of charging status data recommending adoption of the preset charging program as well as recommending values for parameters which would increase a life of the traction battery 102.

As an example, table 1 depicts a look up table which specifies minimum time slots to be allotted for recharging the traction battery 102. The times correspond to the amount of charged needed to recharge the battery 102 from current SOC to desired SOC. Therefore, if the battery 102 is discharged to 50% and an SOC of 90% is required (e.g., for a planned journey or by user preference) the computer 104, 114, 124 may allot time to charge 40% of SOC.

TABLE 1

| SOC | Allotted | |
|---|---|---|
| recharge | recharging time | |
| 100% | 8 | hours |
| 90% | 7 | hours |
| 80% | 6 | hours |
| 70% | 5 | hours |
| 60% | 4 | hours |
| 50% | 3 | hours |
| 40% | 2 | hours |
| 30% | 1 | hour |
| 20% | 0.5 | hours |

The charge algorithm may utilize Table 1, among other lookup tables, to determine the simulation 200. For example, if the vehicle 100 has a journey planned as result of operation patterns or inputted by the user, the computer 104, 114, 124 may determine the minimum SOC needed for the journey based on global navigation data as well as known public charging station 122 locations and assign simulation 200 recharging time sufficient to achieve the minimum SOC while still providing discharged power to the household 110. The charge algorithm may interrupt traction battery 102 discharging based on the minimum required SOC and the time required to charge to the required SOC. For example, if the vehicle 100 triggers the simulation 200 with 50% SOC and is permitted to discharge to 30%, and has a journey scheduled for which the vehicle 100 requires 90% SOC (e.g., a difference of 60%), the computer 104, 114, 124 may reference Table 1 and set the simulation 200 such that the traction battery 102 discharges until 4 hours before the journey, then begins recharging. As a further example, if the household 110 power consumption is low enough that the traction battery 102 SOC remains at 50% 4 hours before the journey, the computer 104, 114, 124 may extend discharge time as a result of the shortened time required to charge from 50% to 60% SOC. Yet further, the computer 104, 114, 124 may continuously calculate the time required to recharge to the required SOC even while the traction battery 102 is discharging. If the computer 104, 114, 124 determines that the battery 102 SOC has dropped such that any further drop would result in insufficient time to recharge such that the SOC reaches the required level, the computer 104, 114, 124 may adjust the simulation 200 to cease discharging and begin recharging.

The computer 104, 114, 124 may utilize the charge algorithm to optimize a charging schedule of the traction battery 102 with power consumption of the household 110. For example, the charge algorithm may reference lookup tables mentioned above specifying outputs for certain inputs. Some lookup tables may accept other tables' outputs as inputs (e.g., a lookup table specifying how long to allow discharging may have as an input how long it would take to charge the battery 102 to a specific SOC). The charge algorithm may determine the third set of charging status data based on one or more objectives. The objectives may include in order of priority: achieving the minimum SOC as specified by the user, achieving the minimum SOC as required to make a planned journey, maximizing discharge, and extending batter life. The computer 104, 114, 124 may receive the first and second sets of charging status data as inputs and utilize the charge algorithm along with the lookup tables to determine a simulation 200 which keeps the traction battery 102 SOC above the minimum specified SOC, achieves the minimum SOC required to make a planned journey by the time the planned journey is set to begin, maximizes discharge after ensuring the previous two objectives are met, and extends the life of the battery 102.

The third set of charging status data may include a selection of a preset charging program from a plurality of preset charging programs. The preset charging programs may be set by a utility company or a manufacturer or fleet operator of the vehicle 100. Each preset charging program may define rates of charging the vehicle 100, allotted quantities of charging for the vehicle 100, and/or pricing for charging. The pricing may include pricing by time of day, by frequency or amount of charging, a flat rate, etc. The simulation may optimize the third set of charging status data by selecting an optimal preset charging program from the preset charging programs. The optimal preset charging program may be optimal in terms of pricing, keeping the vehicle 100 charged according to the preferences of the user, extending a lifetime of the traction battery 102, etc. The computer 104, 114, 124 may enroll the user in the selected preset charging program with the utility company or manufacturer or fleet operator. The preset charging programs may be subscription-based. Enrolling the user in the selected preset charging program may include unenrolling the user from a previously selected preset charging program.

Alternatively or additionally, the third set of charging status data may include adjustments to any or all of the data points of the first and second sets of charging status data. For example, the third set of charging status data may include values for parameters defining the charging and/or discharging of the vehicle 100 and/or the household 110. The parameters may include minimum and maximum allowable state of charge for the vehicle 100, preferred charging time and preferred discharging time, discharging limits (e.g., daily or weekly), etc.

The third set of charging status data includes a level of charge to be transferred between the household 110 and the vehicle 100 (e.g., as part of the preset charging program or as one of the parameters). That is, the charge algorithm may determine how much charge to discharge from the traction battery 102 to the household 110 as well as how much charge to provide from the household 110 to the traction battery 102 via the home charging station 112. The charge algorithm may calculate levels of charge to be transferred based on data from the first and second sets of data including an absolute minimum SOC to be maintained on the traction battery 102, operation patterns (e.g., planned trips of the vehicle 100), a minimum SOC needed for the vehicle 100 to complete a planned journey, user preferences (e.g., a user specifying a specific SOC to be maintained, a threshold household 110 consumption before discharging the traction battery 102, etc.). The charging algorithm may prevent the traction battery 102 from discharging in scenarios where the traction battery 102 has a SOC below a specified minimum SOC when the traction battery 102 is connected to the home charging station 112. For example, if a user specifies a minimum SOC of 30% be maintained and the traction battery 102 has an SOC of 20%, the computer 104, 114, 124 may simulate and actuate the home charging station 112 to charge the traction battery 102 to 30% or above and not simulate or actuate any further discharging (e.g., so as to prevent a redundant exchange of charge between the vehicle 100 and household 110).

The third set of charging status data includes user preferences (e.g., as parameters). As mentioned above, the computer 104, 114, 124 may receive user input and adjust the simulation 200 based on the user input. For example, the user may specify a minimum SOC which the traction battery 102 must maintain at specific times (e.g., the traction battery 102 is specified to maintain at least 30% SOC during the hours of 20:00-7:00). As further mentioned above, the charging algorithm may prioritize objectives and determine the simulation 200 based on the relative priority of the objectives. Maintaining a specified minimum charge may be the highest priority objective followed by maintaining sufficient charge for planned journeys, etc. In the event that the vehicle 100 connects to the home charging station 112 with a SOC below the specified minimum, the computer 104, 114, 124 may recommend in the simulation 200 that the traction battery 102 is charged to the minimum SOC.

Generating the third set of charging status data includes optimizing a service-life of a battery 102 by interrupting the charge. Battery 102 life may be extended where the SOC is kept between 20% and 80%. The computer 104, 114, 124 may adjust the charging algorithm to extend the service-life of the traction battery 102 based on stored instructions or based on user input that authorizes the computer 104, 114, 124 to do so. In an example scenario where the computer 104, 114, 124 requires user approval, if the user approves of the computer 104, 114, 124 adjusting the charging algorithm to extend the service-life of the traction battery 102, the computer 104, 114, 124 may prioritize the objective of prolonging traction battery service-life above the remaining objectives. In such an example the computer 104, 114, 124 may determine the simulation 200 such that the global minimum SOC and global maximum SOC optimize battery 102 service life as specified by stored instructions (e.g., 20% minimum and 80% maximum). Additionally, the computer 104, 114, 124 may adjust the global minimum SOC and global maximum SOC based on planned journeys. For example, if a planned journey has a duration below a specified length (e.g., 40 miles) the computer 104, 114, 124 may decrease the maximum SOC by a specified amount stored in memory (e.g., 60% instead of 80%).

Generating the third set of charging status data may include optimizing an estimation of monetary savings compared with the first and second sets of charging status data. Based on data from the first and second sets of charging status data including the household 110 consumption, the utilities plan, the operating patterns of the vehicle 100 (e.g., how much, if any, additional SOC the traction battery 102 receives from public charging stations 122 during journeys which may then be discharged to the household 110), etc., the computer 104, 114, 124 may determine the simulation 200 so as to optimize savings of the user. For example, if the operation patterns of the vehicle 100 indicate (e.g., as determined by the computer 104, 114, 124 based on historical data) that the vehicle 100 travels to a location with a public charging station 122 on specific days, the computer 104, 114, 124 may adjust the simulation 200 to reduce a charging time at the home charging station 112 in relation to a length of time the vehicle 100 spends at the public charging station 122. As another example, the computer 104, 114, 124 may request permission from the operator to prioritize price above maintaining a minimum charge and thus discharge a larger portion of the SOC to the household 110. As another example, the computer 104, 114, 124 may select a price-optimal preset charging program from the preset charging programs.

The computer 104, 114, 124 is programmed to actuate one or both of the household 110 and/or vehicle 100 to charge according to the third set of charging status data. For example, the computer 104, 114, 124 may actuate the vehicle 100 to charge at rates of charging and within allotted times or quantities of charging specified by the selected preset charging plan. For another example, the computer 104, 114, 124 may actuate the vehicle 100 to charge according to the parameters, such as up to the maximum allowable state of charge or starting at the preferred charging time. The computer 104, 114, 124 may actuate the household 110 and/or vehicle 100 based on stored permissions or may request permission from the user. In an example where the computer 104, 114, 124 is able to or permitted to actuate the household 110 and/or vehicle 100, the computer 104, 114, 124 may discharge the traction battery 102 to the household 110 at times specified by the simulation 200 and interrupt charging the traction battery 102 at times specified by the simulation 200. The computer 104, 114, 124 may additionally adjust maximum or minimum SOC of the traction battery 102 as described above.

The computer 104, 114, 124 may actuate the traction battery 102 to charge according to the third set of charging status data based on a determination to override user preferences. The computer 104, 114, 124 may store permissions in memory (e.g., from a development stage) to override user preferences in specified scenarios where the computer 104, 114, 124 determines to do so. For example, the computer 104, 114, 124 may store permissions to override a user preference that the traction battery 102 have a minimum SOC of 100%. Rather, the computer 104, 114, 124 may override the preference and treat the minimum SOC as 80% in order to extend a service-life of a battery 102. The computer 104, 114, 124 may, for example, override user preferences where the user has previously permitted the computer 104, 114, 124 to do so (e.g., by subscribing to the service plan mentioned above).

FIG. 2A illustrates an example simulation 200 (based on the first and second data sets as described above) including the predicted charging schedule 205 and the virtual model 210. The computer 104, 114, 124 predicts a schedule of the vehicle 100 based on the first data set and propagates the predicted charging schedule 205. The predicted charging schedule 205 predicts to discharge 20% of SOC from T1 until time T2, then at T3 to recharge 40% until T4 and to stand by until T5 when the vehicle 100 is used by the operator and expends 20% SOC (e.g., −20% expected charge). The simulation 200 further predicts that at time T6 the traction battery 102 discharges 30% SOC until T7 and stands by until T8 when the traction battery 102 recharges 40%. At T9 the vehicle 100 stands by until T10 when the vehicle 100 is used and experiences −25% expected charge. At T11 the vehicle 100 returns to the home charging station 112 and stands by until discharging 30% SOC until T12 whereupon the predicted charging schedule 205 ends. The virtual model 210 shows that by T4 the user deviates from the predicted charging schedule 205 in that only 16% SOC is discharged between T1 and T2 and there is only enough time to recharge 30% from time T3 to T4, whereupon the vehicle disconnects from the charging station 112. Accordingly, the computer 104, 114, 124 propagates the virtual model 210.

FIG. 2B illustrates a continuation of FIG. 2A wherein the user further deviates from the predicted charging schedule 205. In addition to the deviations between T1 and T4 shown in FIG. 2A, at T7 the vehicle 100 returns to the home charging station 112 having expended 30% SOC rather than the 20% predicted by the predicted charging schedule 205. The vehicle 100 plugging into the home charging station 112 is a trigger (as described above), which causes the computer 104, 114, 124 to adjust the simulation 200. At T7, based on the virtual model 210 as well as the first and second data sets, the computer adjusts the predicted charging schedule 205 to predict no discharging at T6 but rather to stand by from T7 to T8 before charging. At T8 the computer adjusts the predicted charging schedule 205 to predict that the traction battery 102 recharges 45% SOC until T9 when the vehicle 100 stands by, rather than the original predicted of 40% SOC recharge. At T10 the vehicle 100 is used and is predicted to expend 25% SOC until T11 when the vehicle 100 is returned to the home charging station 112. At T12 the traction battery 102 discharges 30% SOC until T13 when the vehicle 100 stands by and the predicted charging schedule 205 ends.

FIG. 2C illustrates a further continuation of FIGS. 2A and 2B. The vehicle 100 returns to the home charging station 112 at T7 and begins recharging at T8. However, the actual data represented in the virtual model 210 again deviates from the predicted charging schedule 205 in that the vehicle 100 only recharges 30% SOC rather than the predicted 45%. The computer 104, 114, 124 awaits the next trigger.

FIG. 2D illustrates a further continuation of FIGS. 2A-2C. The vehicle 100 returns to the home charging station 112 at T9 having expended 70% SOC rather than the predicted 25% SOC. Therefore, the computer 104, 114, 124 updates the predicted charging schedule 205 such that at T9 the vehicle 100 is predicted to recharge 50% SOC before standing by from T10-T11 whereupon the vehicle will discharge 40% SOC from T11 through T12 into T13.

FIG. 2E illustrates a further continuation of FIGS. 2A-2D. The vehicle 100 disconnects from the home charging station 112 after T13 while keeping the predicted charging schedule 205 between T9 and T13.

FIG. 2F illustrates a further continuation of FIGS. 2A-2E. The timeline has progressed to the end of the predicted charging schedule. The computer 104, 114, 124 then propagates the virtual model 210 representing the actual data of the vehicle 100. The computer 104, 114, 124 may propagate the virtual model 210 using further data from the third data set as described above.

### Example Processes

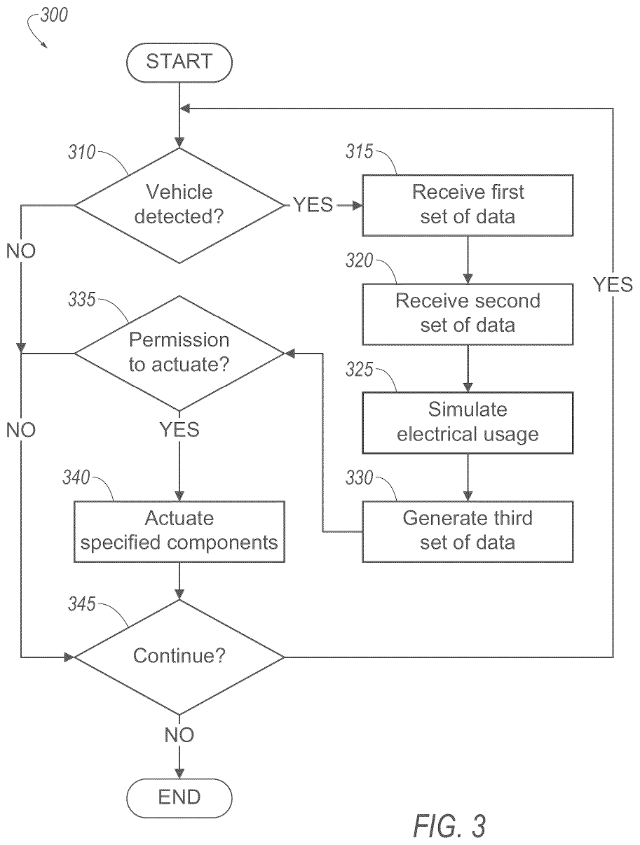

FIG. 3 is a flowchart illustrating an example process 300 for actuating the household 110 and/or vehicle 100 based on the third set of charging status data produced by the simulation 200. The memory of the computer 104, 114, 124 stores executable instructions for performing the steps of the process 300 and/or programming can be implemented in structures such as mentioned above. As a general overview of the process 300, the computer 104, 114, 124 detects the vehicle 100. In response to the vehicle 100 being detected, the computer 104, 114, 124 receives the first set of charging status data, receives the second set of charging status data, simulates the electrical usage, generates the third set of charging status data, and determines whether the computer 104, 114, 124 has permission to actuate the vehicle 100 and/or household 110. In response to the computer 104, 114, 124 having permission to actuate the vehicle 100 and/or the household 110, the computer 104, 114, 124 actuates the vehicle 100 and/or household 110. The process 300 may continue for as long as the computer 104, 114, 124 remains on.

The process beings in a block 310, in which the computer 104, 114, 124 detects whether a trigger event occurred, as described above. In the example of FIG. 2, the trigger event is the vehicle 100 connecting to the home charging station 112. In response to a trigger event occurring, the process 300 proceeds to a block 315. Otherwise, the process 300 proceeds to a decision block 345.

In the block 315, the computer 104, 114, 124 receives the first set of charging status data from the vehicle 100 as described above.

Next, in a block 320, the computer 104, 114, 124 receives the second set of charging status data from the household 110 as described above

Next, in a block 325, the computer 104, 114, 124 simulates the electrical usage of the household 110 based on the second set of charging status data as described above.

Next, in a block 330, the computer 104, 114, 124 generates the third set of charging status data based on the first set of charging status data and the second set of charging status data as described above. The computer 104, 114, 124 may utilize the charge algorithm, which may prioritize various objectives and therefore produce differing outputs.

Next, in a decision block 335, the computer 104, 114, 124 determines whether it has permissions to actuate the household 110 and/or vehicle 100 to charge according to the third set of charging status data as described above. The permissions may be pre-stored by the computer 104, 114, 124 or given by the operator. Additionally, or alternatively, the permission may come as part of the preset charging program. If the computer 104, 114, 124 has permission, the process 300 continues to a block 340. Otherwise, the process continues to the decision block 345.

In the block 340 the computer 104, 114, 124 actuates the household 110 and/or vehicle 100 to charge or discharge according to the third set of charging status data as described above. After the block 340, the process 300 proceeds to the decision block 345.

In the decision block 345, the computer 104, 114, 124 determines whether to continue the process 300. For example, the computer 104, 114, 124 may determine the simulation 200 for the next twenty-four hours and cease operation until a trigger event occurs as described above. In response to a trigger event, the process 300 returns to the block 310. Otherwise the process 300 ends.

Computing devices such as those discussed herein generally each includes commands executable by one or more computing devices such as those identified above, and for carrying out blocks or steps of processes described above. For example, process blocks discussed above may be embodied as computer executable commands.

Computer executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands (i.e., from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Use of in response to, based on, and upon determining herein indicates a causal relationship, not merely a temporal relationship. “Based on” or “in response to” can mean based at least partly on or at least partly in response to unless explicitly stated otherwise.

Examples are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the Figures should not be viewed as limiting. It should be understood that other embodiments might include more or less of each element shown in a given Figure. Additionally, some of the illustrated elements may be combined or omitted. Yet further, an example embodiment may include elements that are not illustrated in the Figures.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described. The adjectives “first,” “second,” and “third” are used throughout this document as identifiers and are not intended to signify importance, order, or quantity. Operations, systems, and methods described herein should always be implemented and/or performed in accordance with an applicable user's manual and/or guidelines.

1. A system comprising a computer having a processor and a memory, the memory storing instructions executable by the processor to:
receive a first set of charging status data about a vehicle;
receive a second set of charging status data about a household associated with the vehicle;
based on the sets of charging status data, simulate electrical usage by the vehicle and the household to generate a third set of charging status data; and
actuate at least one of the vehicle or the household to charge according to the third set of charging status data.

2. The system of claim 1, wherein the first set of charging status data includes a vehicle charging schedule.

3. The system of claim 1, wherein the second set of charging status data includes a utilities plan of the household.

4. The system of claim 1, wherein the sets of charging status data include user preferences.

5. The system of claim 1, wherein the second set of charging status data includes household power consumption.

6. The system of claim 1, wherein the first set of charging status data includes operation patterns of the vehicle.

7. The system of claim 1, wherein the sets of charging status data include a level of charge to be transferred between the household and the vehicle.

8. The system of claim 1, wherein the instructions further include instructions to charge according to the third set of charging status data based on a determination to override user preferences.

9. The system of claim 1, wherein generating the third set of charging status data includes optimizing a service-life of a battery by interrupting the charge.

10. The system of claim 1, wherein the third set of charging status data includes a selection from a plurality of preset charging programs.

11. The system of claim 1, wherein generating the third set of charging status data includes optimizing an estimation of monetary savings compared with the first and second sets of charging status data.

12. A method comprising:
receiving a first set of charging status data about a vehicle;
receiving a second set of charging status data about a household associated with the vehicle;
based on the sets of charging status data, simulating electrical usage by the vehicle and the household to generate a third set of charging status data; and
actuating at least one of the vehicle or the household to charge according to the third set of charging status data.

13. The method of claim 12, wherein the first set of charging status data includes a vehicle charging schedule.

14. The method of claim 12, wherein the second set of charging status data includes a utilities plan of the household.

15. The method of claim 12, wherein the sets of charging status data include user preferences.

16. The method of claim 12, wherein the second set of charging status data includes household power consumption.

17. The method of claim 12, wherein the first set of charging status data includes operation patterns of the vehicle.

18. The method of claim 12, wherein the sets of charging status data include a level of charge to be transferred between the household and the vehicle.

19. The method of claim 12, further comprising charging according to the third set of charging status data based on a determination to override user preferences.

20. The method of claim 12, wherein generating the third set of charging status data includes optimizing a service-life of a battery by interrupting the charge.
